(19) United States
(12) Patent Application Publication
(10) Pub. No.: US 2018/0354105 A1
(43) Pub. Date: Dec. 13, 2018

(54) TOOL BIT ADAPTER HAVING A MAGNETIC ATTRACTION EFFECT

(71) Applicant: GOOD YEAR HARDWARE CO., LTD., Changhua (TW)

(72) Inventor: Tsai-Ching CHEN, Changhua (TW)

(21) Appl. No.: 15/990,272

(22) Filed: May 25, 2018

(30) Foreign Application Priority Data
Jun. 13, 2017 (DE) 102017112949.9

(51) Int. Cl. B25B 23/00

(52) U.S. Cl. CPC B25B 23/0035; B25B 21/00

(57) ABSTRACT

A tool bit adapter having a magnetic attraction effect includes a shank having one end for connection to a power tool and an opposite end provided with an adapter block that defines therein an accommodation chamber for accommodating a tool bit and a position-limiting groove and an abutment portion in the accommodation chamber, and a movable block movably mounted in the position-limiting groove and provided with a magnetic attraction member that provides a magnetic attractive force toward the inserted tool bit for causing the movable block to move from a first position where the magnetic attraction end of the magnetic attraction member is disposed at an inner side relative to the abutment portion to a second position wherein the magnetic attraction end of the magnetic attraction member is kept in flush with the abutment portion or disposed outside the abutment portion to attract the tool bit positive in place.

### BACKGROUND OF THE INVENTION

### 1. Field of the Invention

The present invention relates to hand tool technology and more particularly, to a tool bit adapter having a magnetic attraction effect.

### 2. Description of the Related Art

Using a magnetic member in a tool bit adapter for securing the inserted tool bit is known, and exemplars are seen in Taiwan Patent Numbers M325898 and M325899. The use of a magnetic member can enhance tool bit positioning effect. However, in the aforesaid two prior art designs, the magnetic member is fixedly mounted in place. When a tool bit adapter is coupled to a power tool and operated, an impact or shock will be produced, and the produced impact or shock will be fully transferred to the magnetic member without buffering. When the magnetic member is disposed under shock and impact in a long time under the shock and impact, the service life of the magnetic member will be shortened.

In order to solve the aforesaid problem Taiwan Patent Number M384743 discloses a magnetic screw driving mechanism, which comprises a driving tool, a magnetic attraction member and a positioning ring. The driving tool has a non-circular tool hole located in a front end thereof, an accommodation chamber of relatively smaller diameter disposed in communication with the non-circular tool hole, an expanded located at an opposing rear end thereof, a through hole axially located in the bottom side of the expanded flange, and an elastic member mounted in the through hole. The positioning ring defines therein a coupling hole mating with the magnetic attraction member. The diameter of the coupling hole is smaller than the diameter of the diameter of the expanded flange. Further, the positioning ring has teeth arranged round the outer periphery thereof. Thus, the arrangement of the elastic member can buffer the magnetic attraction member and reduce the pressure born by the magnetic attraction member.

The design of M384743 uses an elastic member to provide buffering and pressure-reducing effects to the magnetic attraction member. However, the use of the elastic member complicates the installation of the tool bit adapter and relatively increases its manufacturing costs.

### SUMMARY OF THE INVENTION

The present invention has been accomplished under the circumstances in view. It is the main object of the present invention to provide a tool bit adapter having a magnetic attraction effect, which effectively protects the magnetic attraction member.

It is another object of the present invention to provide a tool bit adapter having a magnetic attraction effect, which facilitates installation, saving much installation labor and time.

It is still another object of the present invention to provide a tool bit adapter having a magnetic attraction effect, which saves the manufacturing costs.

To achieve these and other objects of the present invention, a tool bit adapter having a magnetic attraction effect comprises a shank and a movable block. The shank comprises an adapter block located at one end thereof, an accommodation chamber curved inwardly from an outer side of the adapter block toward an inner side thereof, and a position-limiting groove defined in the accommodation chamber. The accommodation chamber comprises an abutment portion. The accommodation chamber is adapted for receiving a tool bit that has a bottom end adapted for abutting against the abutment portion upon insertion of the tool bit into the accommodation chamber. The position-limiting groove has an annular flange defined therein. Further, the shank has an opposite end thereof adapted for connection to a power tool. The movable block is movably mounted in the position-limiting groove, comprising a stopper and a magnetic attraction member. The magnetic attraction member has a magnetic attraction end. The stopper is used to abut against the annular flange to stop the movable block from falling out of the position-limiting groove. The magnetic attraction member is mounted to face toward the accommodation chamber. Thus, when the tool bit is plugged into the accommodation chamber, the movable block is moved from a first position to a second position subject to the magnetic attractive force generated between the magnetic attraction member of the movable block and the tool bit. When the movable block is located at the first position, the magnetic attraction end of the magnetic attraction member is disposed at an inner side relative to the abutment portion. On the contrary, when the movable block is moved to the second position, the magnetic attraction end of the magnetic attraction member is kept in flush with the abutment portion or disposed outside the abutment portion to attract the inserted tool bit.

Thus, when the movable block is in the first position, the magnetic attraction end of magnetic attraction member is disposed in an inner side relative to the abutment portion, and when the tool bit is plugged into the accommodation chamber and abutted against the abutment portion at this time, the magnetic attractive force of the magnetic attraction member toward the tool bit causes the movable block to move to the second position, keeping the magnetic attraction end of the magnetic attraction member in flush with the abutment portion, and thus, the magnetic attraction member can be well protected.

Since the invention eliminates the use of an elastic member as seen in the prior art design, the invention effectively reduces the installation time.

Further, eliminating the use of an elastic member also effectively reduces the tool bit adapter manufacturing cost.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic sectional view of tool bit adapter in accordance with a first embodiment of the present invention, illustrating a movable block in a first position.

FIG. 2 is similar to FIG. 1, illustrating the movable block in a second position.

FIG. 3 is a schematic applied view of the first embodiment of the present invention, illustrating a tool bit inserted into the accommodation chamber.

FIG. 4 is another schematic applied view of the first embodiment of the present invention, illustrating an isolation between the stopper and the annular flange.

FIG. 5 is another schematic applied view of the first embodiment of the present invention, illustrating an isolation between the tool bit and the annular flange.

FIG. 6 is a schematic applied view of a tool bit adapter in accordance with a second embodiment of the present invention.

### DETAILED DESCRIPTION OF THE INVENTION

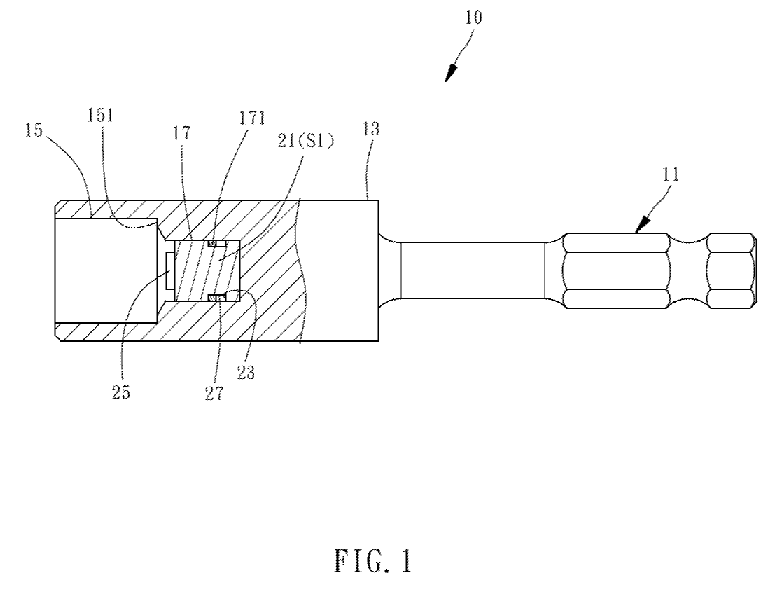

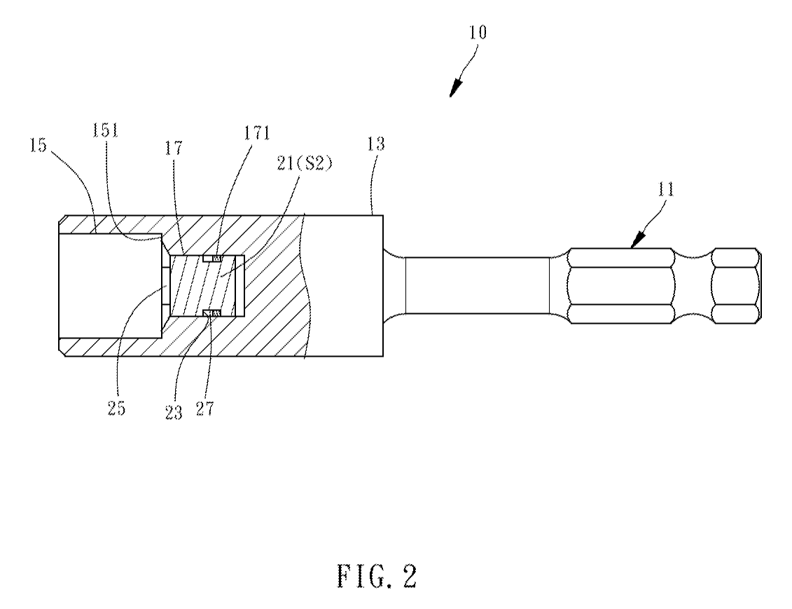

Referring to FIGS. 1-3, a tool bit adapter 10 having a magnetic attraction effect is shown. The tool bit adapter 10 comprises a shank 11 and a movable block 21.

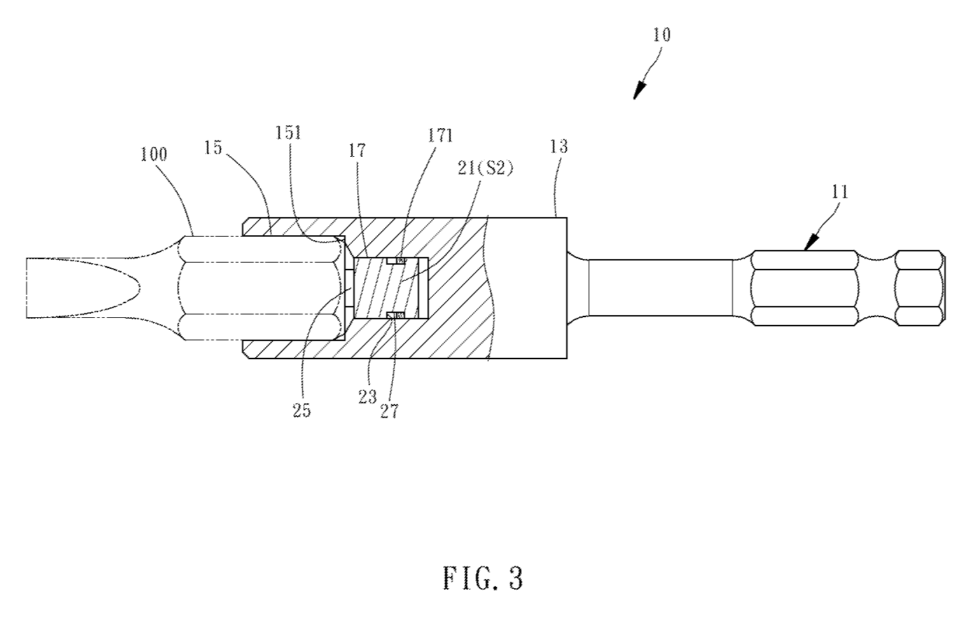

The shank 11 comprises an adapter block 13 located at one end thereof, an accommodation chamber 15 curved inwardly from an outer side of the adapter block 13 toward an inner side thereof, the accommodation chamber 15, and a position-limiting groove 17 defined in a bottom side of the accommodation chamber 15. The caliber of the accommodation chamber 15 is larger than the caliber of the position-limiting groove 17. The accommodation chamber 15 defines therein an abutment portion 151. Further, the accommodation chamber 15 is adapted for receiving a tool bit 100 (see FIG. 3). When the tool bit 100 is accommodated in the accommodation chamber 15, it is abutted against the abutment portion 151. The position-limiting groove 17 has an annular flange 171 mounted therein. In this embodiment, the annular flange 171 is formed of a C-shaped retaining ring. The annular flange 171 is interfered with an inside wall of the position-limiting groove 17, and friction force between the annular flange 171 and the inside wall of the position-limiting groove 17 is greater than the magnetic attractive force of a predetermined magnetic attraction member 25 toward the tool bit 100. In another embodiment, the annular flange 171 is formed of an O-ring (not shown). Therefore, the type of the annular flange 171 is not limited to the design of this first embodiment. The opposite end of the shank 11 is adapted for connection to a power hand tool (that is a conventional tool to mate with the tool bit adapter 10 and not illustrated in the drawings).

The movable block 21 is movably mounted in the position-limiting groove 17, comprising a stopper 23 and a magnetic attraction member 25. The stopper 23 is used to against the annular flange 171 to stop the movable block 21 from falling out of the position-limiting groove 17. Further, the movable block 21 comprises an annular groove 27 extended around the periphery thereof and configured to mate with the annular flange 171. The stopper 23 is disposed in the annular groove 27. The magnetic attraction member 25 is mounted face toward the accommodation chamber 15.

When the tool bit 100 is plugged into the accommodation chamber 15, the magnetic attraction member 25 of the movable block 21 attracts the tool bit 100, causing the movable block 21 to be moved from a first position S1 to a second position S2. When the movable block 21 is in the first position S1, the magnetic attraction end of the magnetic attraction member 25 is disposed in the abutment portion 151; on the contrary, when the movable block 21 is in the second position S2, the stopper 23 of the movable block 21 is abutted against the annular flange 171, and the magnetic attraction end of the magnetic attraction member 25 is disposed in flush with the abutment portion 151 to positively attract the tool bit 100.

After illustration of the structure of the first embodiment of the present invention, the application of the first embodiment of the present invention is outlined hereinafter.

Referring to FIGS. 1 and 3 again, when the tool bit 100 is plugged into the accommodation chamber 15, the bottom end of the tool bit 100 is abutted against the abutment portion 151, the movable block 21 is moved from the first position S1 to the second position S2 subject to the magnetic attractive force between the magnetic attraction member 25 and the tool bit 100, and thus the bottom end of the tool bit 100 is positively secured to the magnetic attraction member 25. Since the annular flange 171 is interfered with the inside wall of the position-limiting groove 17 and the friction force between the annular flange 171 and the position-limiting groove 17 is greater than the magnetic attractive force between the magnetic attraction member 25 and the tool bit 100, the annular flange 171 can effectively stop the movable block 21 in the position-limiting groove 17.

When the power tool is started up, the impact or shock received by the tool bit 100 is transferred to the abutment portion 151 and the magnetic attraction member 25. If the impact or shock is smaller than the magnetic attractive force between the magnetic attraction member 25 and the tool bit 100, the abutment portion 151 can bear a part of the impact of shock that is received by the magnetic attraction member 25 so that the magnetic attraction member 25 does not sustain all the impact of shock, providing protection to the magnetic attraction member 25; if the impact or shock is greater than the magnetic attractive force between the magnetic attraction member 25 and the tool bit 100, the movable block 21 will carry the magnetic attraction member 25 to move from the second position S2 toward the first position S1, at this time, the magnetic attraction member 25 is not kept in contact with the tool bit 100, avoiding the magnetic attraction member 25 from continuously receiving the impact or shock and providing protection to the magnetic attraction member 25. The moving range of the movable block 21 is determined subject to the degree that the impact or shock surpasses the magnetic attractive force of the magnetic attraction member 25. Thereafter, as soon as the magnetic attractive force between the magnetic attraction member 25 and the tool bit 100 surpasses the impact or shock born by the magnetic attraction member 25, the movable block 21 immediately returns to the second position S2, allowing the magnetic attraction member 25 to attract the bottom end of the tool bit 100 again.

Thus, when the movable block 21 is in the first position S1, the magnetic attraction end of magnetic attraction member 25 is disposed in an inner side relative to the abutment portion 151, and when the tool bit 100 is plugged into the accommodation chamber 15 and abutted against the abutment portion 151 at this time, the magnetic attractive force of the magnetic attraction member 25 toward the tool bit 100 causes the movable block 21 to move to the second position S2,keeping the magnetic attraction end of the magnetic attraction member 25 in flush with the abutment portion 151, and thus, the magnetic attraction member 25 can be well protected.

Since the invention eliminates the use of an elastic member as seen in the prior art design, the invention effectively reduces the installation time.

Further, eliminating the use of an elastic member also effectively reduces the tool bit adapter manufacturing cost.

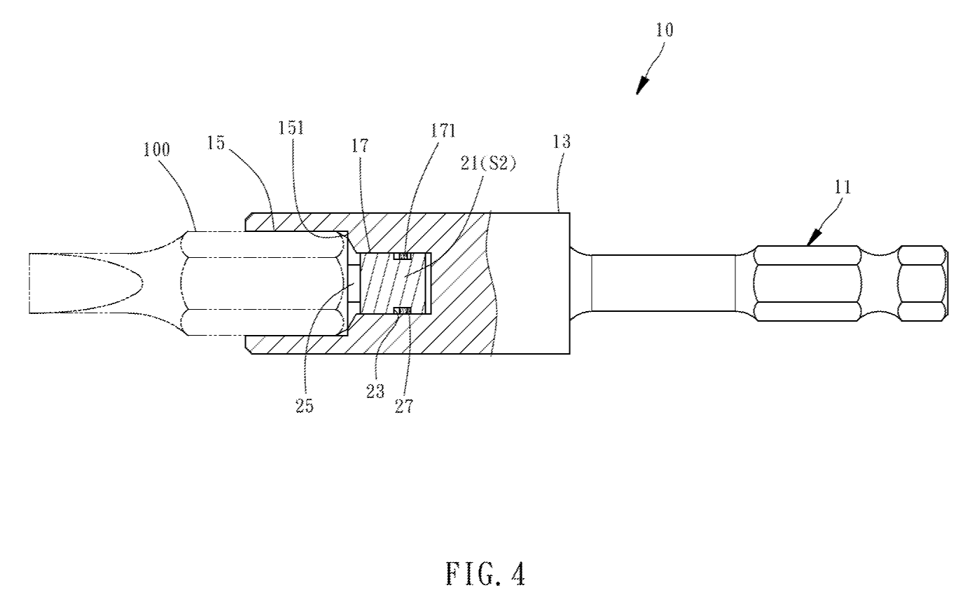

In addition to the above-mentioned configuration, see also FIG. 4, the magnetic attraction member 25 can be made relatively thicker. In this case, when the movable block 21 is moved to the second position S2 where the magnetic attraction member 25 attracts the tool bit 100, the stopper 23 of the movable block 21 is not abutted against the annular flange 171, achieving the same protection effect.

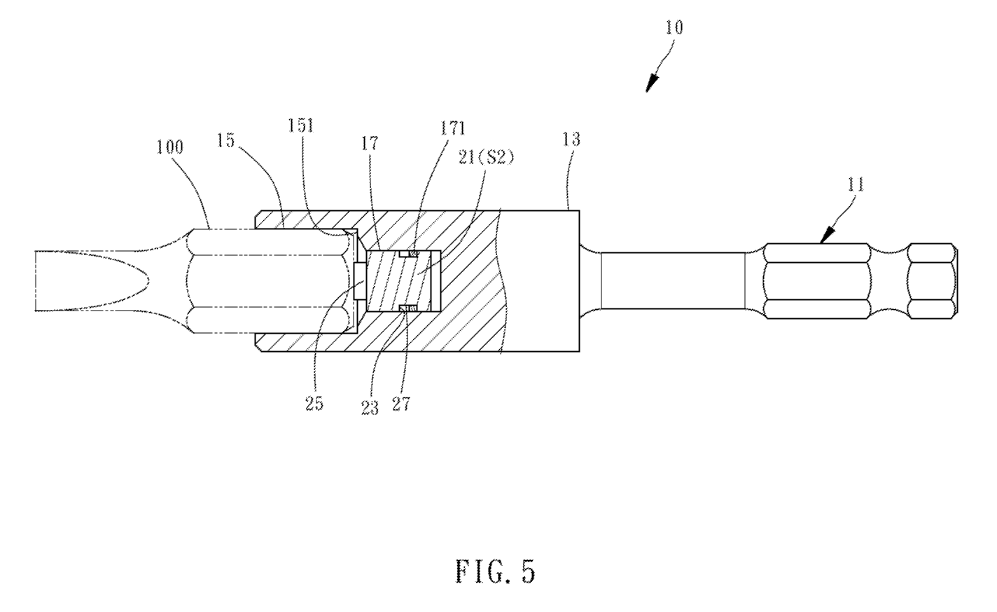

Further, as illustrated in FIG. 5, when the user plugs the tool bit 100 into the accommodation chamber 15, the bottom end of the tool bit 100 may be not accurately abutted against the abutment portion 151. In this case, when the movable block 21 is in the second position S2, the magnetic attraction end of the magnetic attraction member 25 is disposed at an outer side relative to the abutment portion 151, thus, even the bottom end of the tool bit 100 is not positively abutted against the abutment portion 151, the invention can still positively secure the tool bit 100 in position, achieving the same effect of protecting the magnetic attraction member 25 and avoiding damage to the magnetic attraction member 25.

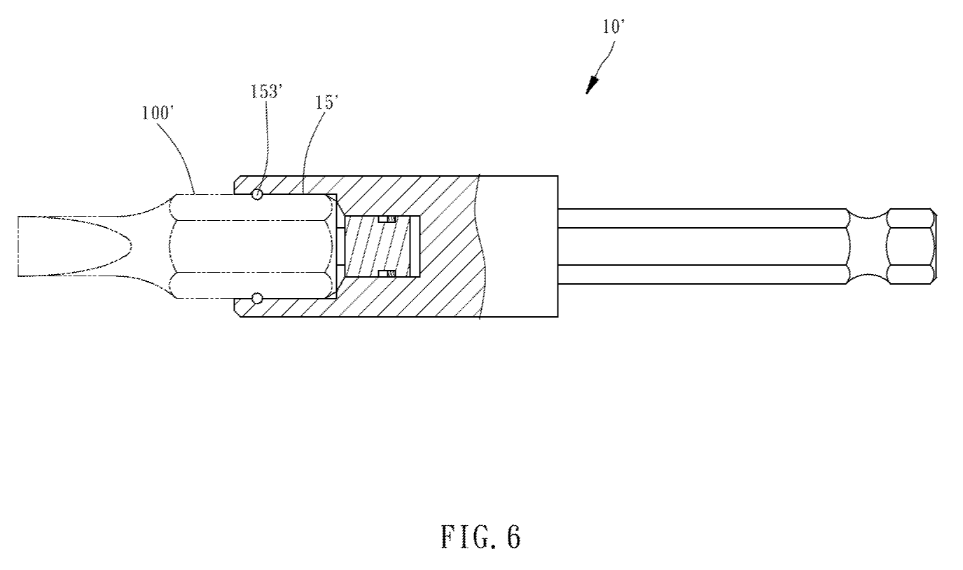

Referring to FIG. 6, a tool bit adapter in accordance with a second embodiment is shown. The tool bit adapter 10′ of this second embodiment is substantially similar to the aforesaid first embodiment with the exceptions as follows:

The tool bit adapter 10′ further comprises a retaining member 153′ mounted in the accommodation chamber 15′. The retaining member 153′ is located at an inside wall of the accommodation chamber 15′ to interfere with the tool bit 100′, enhancing the effect of the accommodation chamber 15′ to secure the tool bit 100′ in place. In this second embodiment, the retaining member 153′ is a C-shaped retaining ring. In other embodiments, O-ring or rolling ball (not shown) can be used for the retaining member 153′. Therefore, the retaining member 153′ is not limited to the example of this second embodiment.

The other part of the structure of this second embodiment and its effects are same as the aforesaid first embodiment, and therefore, no further detailed description in this regard is necessary.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool bit adapter, comprising:
a shank comprising an adapter block located at one end thereof, an accommodation chamber curved inwardly from an outer side of said adapter block toward an inner side thereof, a position-limiting groove defined in said accommodation chamber, said accommodation chamber comprising an abutment portion, said accommodation chamber being adapted for receiving a tool bit, said tool bit having a bottom end adapted for abutting against said abutment portion upon insertion of said tool bit into said accommodation chamber, said position-limiting groove having an annular flange defined therein, said shank having an opposite end thereof adapted for connection to a power tool; and
a movable block movably mounted in said position-limiting groove, said movable block comprising a stopper and a magnetic attraction member, said magnetic attraction member having a magnetic attraction end, said stopper being used to abut against said annular flange to stop said movable block from falling out of said position-limiting groove; said magnetic attraction member is mounted to face toward said accommodation chamber;
wherein, when said tool bit is plugged into said accommodation chamber, said movable block is moved from a first position to a second position subject to the magnetic attractive force generated between said magnetic attraction member of said movable block and said tool bit; when said movable block is located at said first position, said magnetic attraction end of said magnetic attraction member is disposed at an inner side relative to said abutment portion; when said movable block is moved to said second position, said magnetic attraction end of said magnetic attraction member is kept in flush with said abutment portion or disposed outside said abutment portion to attract the inserted said tool bit.

2. The tool bit adapter as claimed in claim 1, wherein when said movable block is in said second position, said stopper of said movable block is abutted against said annular flang.

3. The tool bit adapter as claimed in claim 1, wherein when said movable block is in said second position, said stopper of said movable block is not abutted against said annular flange.

4. The tool bit adapter as claimed in claim 1, wherein the caliber of said accommodation chamber is larger than the caliber of said position-limiting groove.

5. The tool bit adapter as claimed in claim 1, wherein said annular flange is formed of a C-shaped retaining ring.

6. The tool bit adapter as claimed in claim 5, wherein said annular flange is interfere with an inside wall of said position-limiting groove, and the friction force produced due to interference between said annular flange and the said inside wall of said position-limiting groove is larger than the magnetic attractive force between said magnetic attraction member and said tool bit.

7. The tool bit adapter as claimed in claim 1, wherein said movable block comprises an annular groove extended around the periphery thereof and adapted to face toward said annular flange; said stopper is positioned in said annular groove.

8. The tool bit adapter as claimed in claim 1, further comprising a retaining member mounted in aid accommodation chamber and located at an inside wall of said accommodation chamber for interfering with said tool bit to secure said tool bit positively in said accommodation chamber.

9. The tool bit adapter as claimed in claim 8, wherein said retaining member is a C-shaped retaining ring.
